(19) United States
(12) Patent Application Publication
(10) Pub. No.: US 2006/0078134 A1
(43) Pub. Date: Apr. 13, 2006

(54) In-line microphone filter

(76) Inventors: Aleksey S. Khenkin, Peterborough, NH (US); Davis Baskind, Lancaster, PA (US); Lois Irene Baskind, Lancaster, PA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/224,723

(22) Filed: Sep. 12, 2005

Related U.S. Application Data
(60) Provisional application No. 60/608,804, filed on Sep. 10, 2004.

(51) Int. Cl. H04R 3/00

(52) U.S. Cl. 381/113; 381/111

(57) ABSTRACT

An in-line microphone filter may include a housing and a filter circuit housed in the housing. A first connector at one end of the housing is connected to an input of the filter circuit and a second connector at another end of the housing is connected to an output of the filter circuit. The filter circuit may filter the microphone audio signal by changing sonic characteristics of the audio signal in a predetermined manner dependent upon a specific type of acoustic source or instrument.

### CROSS-REFERENCE TO RELATED APPLICATIONS

This application claims the benefit of U.S. provisional patent application Ser. No. 60/608,804, filed Sep. 10, 2004, the entire disclosure of which is incorporated herein by reference.

### FIELD

This disclosure relates to filters and more particularly, to an in-line microphone filter.

### BACKGROUND

A microphone captures sound from an acoustic source such as an instrument and converts the sound energy into electrical energy (i.e., an electrical audio signal), which may be amplified, modified, recorded, etc. When the audio signal is converted back into sound, the quality of the resulting sound may vary depending upon the acoustic source (e.g., the instrument). Although equalizer circuits may be used to modify the audio signal and the quality of the resulting sound, existing microphones do not have the ability to adapt to the unique sounds of different types of instrument in a way that provides a desired sound quality specific to each of the instruments. Microphone pads are available to provide signal level reduction for very loud sound sources (i.e., padding). This signal level reduction, however, is independent of frequency of the signal and does not change the sonic characteristics of the signal.

Accordingly, there is a need for an in-line microphone filter that can be connected in-line with a microphone to change the sonic characteristics of an audio signal based on the acoustic source or instrument.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a block diagram of an embodiment of a system including an in-line microphone filter connected between a microphone and a microphone preamplifier;

FIG. 2 is a schematic diagram of another embodiment of a system including an in-line microphone filter connected between a microphone and a microphone preamplifier.

FIG. 3 is a block diagram of a system including one embodiment of an in-line microphone filter connected between a microphone and a microphone preamplifier;

FIG. 4 is a block diagram of a system including another embodiment of an in-line microphone filter connected between a microphone and a microphone preamplifier;

FIGS. 5 and 6 are perspective views of one embodiment of an in-line microphone filter connected in-line between a microphone and a cable;

FIG. 7 is a perspective view of one embodiment of an in-line microphone filter;

FIG. 8 is a cross-sectional view of one embodiment of an in-line microphone filter;

FIG. 9 is a circuit diagram of one embodiment of a filter circuit in an in-line microphone filter for use with a kick drum;

FIG. 10 is a frequency response plot of one embodiment of the filter circuit for use with a kick drum;

FIG. 11 is a circuit diagram of another embodiment of a filter circuit for use with a snare drum;

FIG. 12 is a circuit diagram of another embodiment of a filter circuit consistent with the present disclosure;

FIG. 13 is a circuit diagram of yet another embodiment of a filter circuit consistent with the present disclosure;

Although the following Detailed Description will proceed with reference being made to illustrative embodiments, many alternatives, modifications, and variations thereof will be apparent to those skilled in the art. Accordingly, it is intended that the subject matter be viewed broadly.

### DETAILED DESCRIPTION

In general, an in-line microphone filter may be used in-line between a microphone and a microphone preamplifier to change the sonic characteristics or spectrum, e.g., change the frequency response, of an audio signal from the microphone, which may be based on an acoustic source, such as an instrument. In some particular disclosed embodiments, the in-line microphone filter is tailored for recording a specific musical instrument such as a kick drum or snare drum. However, those skilled in the art will recognize that an in-line microphone filter consistent with the present disclosure can be designed for other types of acoustic sources, including various other instruments, vocals, non-musical sources, etc.

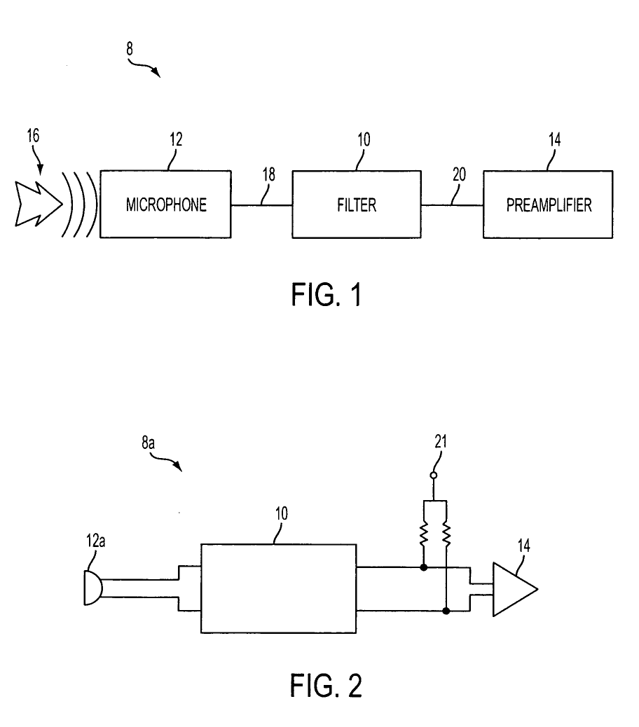

Referring to FIG. 1, a system 8 is shown including an in-line filter 10 coupled between a microphone 12 and a preamplifier 14. As shown, the in-line filter 10 may be coupled in series with the microphone 12 and the preamplifier 14. The in-line filter 10 may be provided as a passive circuit, and may, therefore, not require external power. Consistent with one aspect, the in-line filter 10 may change the sonic characteristics of an audio signal 18 from the microphone 12, which may be based on an acoustic source 16. A modified audio signal 20 may be provided to the preamplifier 14 from the in-line filter 10.

The change in the sonic characteristics of the audio signal may change or create coloration, e.g., frequency response, of the modified audio signal 20 provided to the preamplifier 14, e.g., as compared to the audio signal 18 from the microphone 12. For example, the filter 10 may provide band-reject filtration in a mid-range of frequencies. Accordingly, the modified audio signal 20 received by the preamplifier 14 may exhibit audibly elevated low and high frequencies. In various other embodiments, the in-line filter may provide band-pass, high-pass, low-pass, etc. filtration, each providing a corresponding modified audio signal to the preamplifier. The in-line filter may, or may not, increase or reduce the level of the signal overall, depending upon the application and/or on the desired change in sonic characteristic.

Various additional and/or alternative filtration techniques may also suitably be employed. Furthermore, the in-line filter may include more than one filtration circuit further modifying the audio signal received from the microphone. For example, the in-line filter may include a band pass filter and a band exclusion filter, e.g., with at least partially overlapping frequency ranges to provide a desired effect. Similarly, a plurality of separate in-line filters may be used in combination with one another to achieve a similar effect in a modularized system. Accordingly, one or more in-line filters may be used to provide an optimized modified audio signal for a specific acoustic sources, such as for specific instruments.

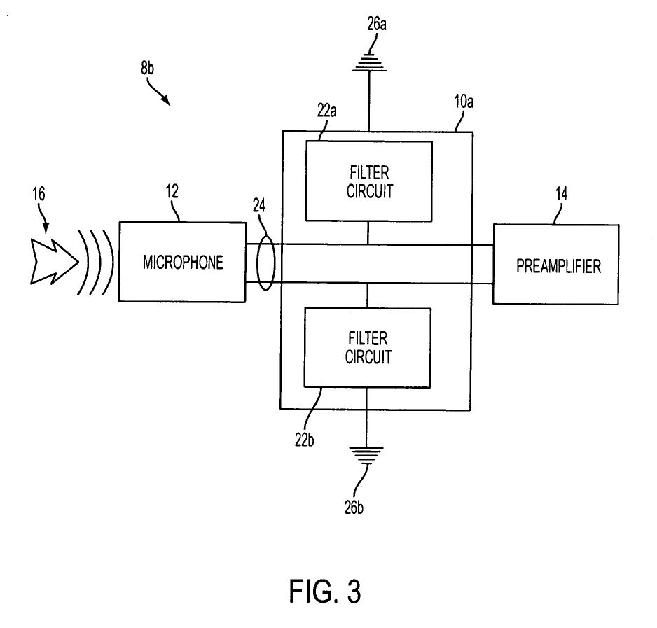

An in-inline amplifier 10 may suitably be used in a system 8a including a microphone 12a adapted to operate with a bias voltage, herein also referred to as a phantom power, such as a condenser microphone as shown in FIG. 2. The phantom power may be provided to the system 8a from a phantom power supply 21. In such an embodiment, the in-line filter 10 may provide a DC pathway from the input to the output for the phantom power though the system 8a. The in-line filter may have a relatively low DC resistance, such as less than about 2 kohms to prevent dissipating the phantom power. The components of the in-line filter may also be capable of handling the phantom power, for example of at least about 50 VDC, without damage.

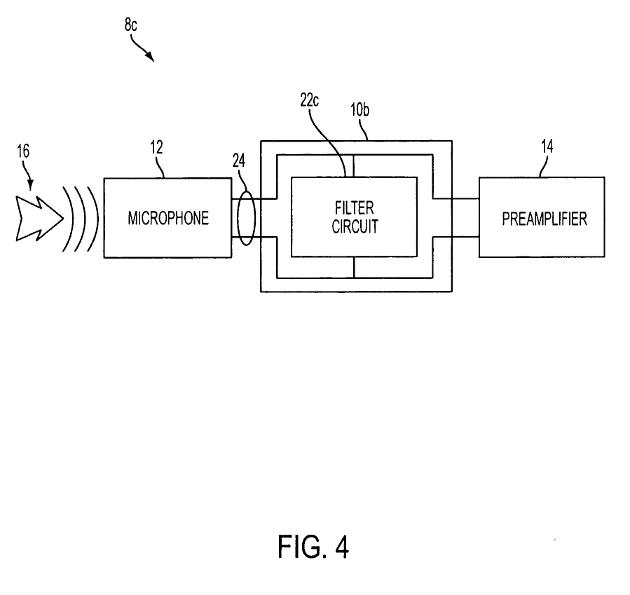

Turning to FIG. 3, in one embodiment an in-line filter 10a may include first and second filter circuits 22a, 22b. The first and second filter circuits 22a, 22b may be associated with respective ones of the differential pair 24 from the microphone. The filter circuits 22a, 22b of the in-line filter 10a may be symmetrical to maintained a balanced line. In one embodiment, the filter circuits 22a, 22b may include respective ground references 26a, 26b. In an embodiment in which the in-line filter includes a reference to ground, the resistance of the ground reference may be at least about 75 ohms to prevent shunting the audio signal to ground.

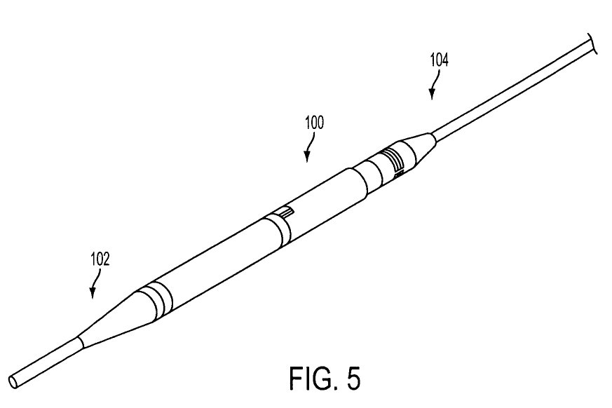

Referring next to FIG. 4, another embodiment of an inline filter 10b may include a filter circuit 22c coupled to each of the differential pair 24. In one such embodiment, instabilities associated with some microphones may be improved by providing the in-line filter 10b not having a ground reference. The filter circuit 22c may reference the respective one of the differential pair 24.

According to one aspect, an in-line microphone filter consistent with the present disclosure may be optimized for microphone level signals and may be packaged in a convenient in-line package that may be simply plugged in to the microphone line in series between the microphone and preamplifier, for example, when recording the instrument. As mentioned, the in-line microphone filter may be provided as a passive filter which also does not require external power.

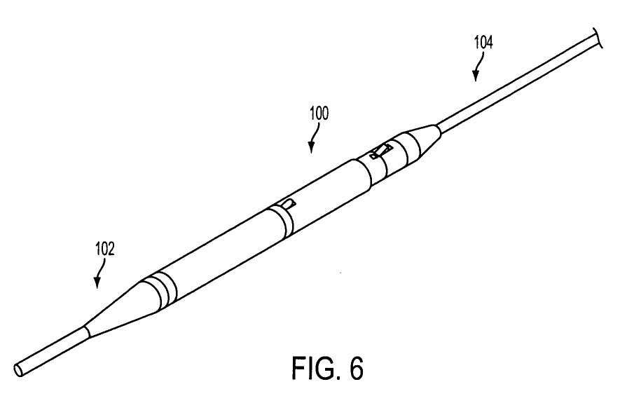

Referring to FIGS. 5 and 6, an embodiment of an in-line microphone filter 100 may be connected in-line, for example, between a microphone 102 and a microphone cable 104. The in-line microphone filter 100 may be used as an accessory to existing microphones such as the type available from Earthworks, Inc. Although the illustrated embodiment shows the in-line microphone filter 100 connected directly between the microphone 102 and the cable 104, the filter 100 may also be indirectly connected in-line with the microphone, for example, with other components connected in series with the microphone 102, filter 100 and cable 104.

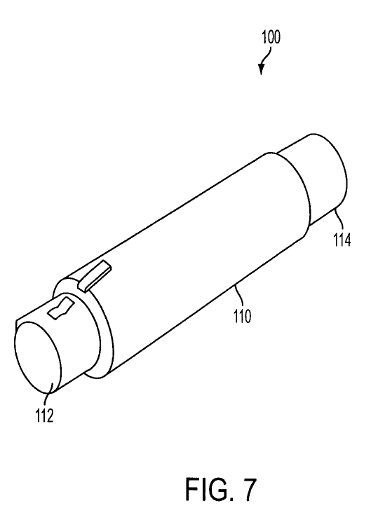

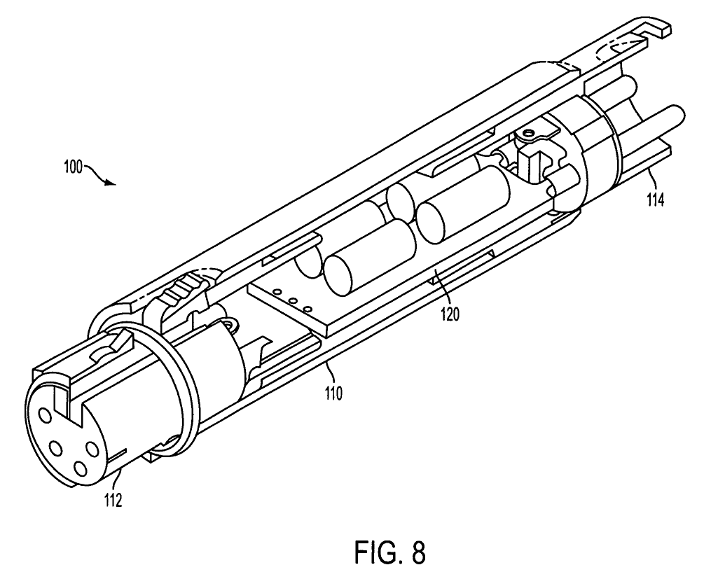

FIGS. 7 and 8 show one embodiment of the in-line microphone filter 100 in greater detail. The illustrated embodiment of the in-line microphone filter 100 includes a housing 110 and first and second connectors 112, 114 at each end of the housing 110. The first connector 112 may be a male connector, for example, configured to connect to the microphone 102. The second connector 114 may be a female connector, for example, configured to connect to the cable 104. Those skilled in the art will recognize that the connectors 112, 114 may be designed to connect to existing microphones and cables. Therefore, as shown in FIGS. 5 and 6, the in-line filter 100 may be directly coupled to the microphone 102 and the microphone cable 104 may be directly coupled to the in-line filter 100. In a related manner, a first microphone cable may couple the in-line filter to the microphone, and a second microphone cable may couple the in-line filter to an upstream component, such as a preamplifier.

A filter circuit board 120 is located in the housing 110 of the in-line filter. The filter circuit board 120 is connected at an input end to one connector 112 and on an output end to the other connector 114. The filter circuit board 120 includes a filter circuit that receives an audio signal from a microphone and changes the sonic characteristics or spectrum of the audio signal to create a particular desired change or “coloration” of the resulting sound. The filter circuit may or may not reduce the overall level of the signal. The actual electrical circuit may be different for different types of instruments and/or for different desired effects, as will be described in greater detail below.

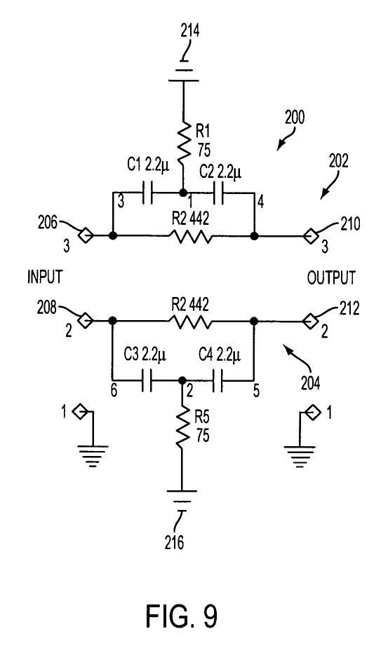

FIG. 9 shows one embodiment of a filter circuit 200 for use with a kick drum. The illustrated filter circuit 200 is configured and designed (e.g., the values of the resistors and capacitors) to change the frequency response of a microphone to improve the sound quality of a recorded kick drum. The filter circuit 200 is a passive circuit, and may not require external power. As shown, the filter circuit 200 may generally include two paths 202, 204 each having respective inputs 206, 208, e.g., from a microphone, and outputs 210, 212. Additionally each of the paths 202, 204 may include a respective ground reference 214, 216, similar to the general embodiment described with reference to FIG. 3. As depicted by the configuration of each path as well as the exemplary capacitance and resistance values, the paths 202, 204 may be symmetrical to provide a balanced line. Additionally, the resistance of the ground reference is sufficient to prevent shunting to ground. In the case of the illustrated circuit the resistance of the ground reference is 75 ohms.

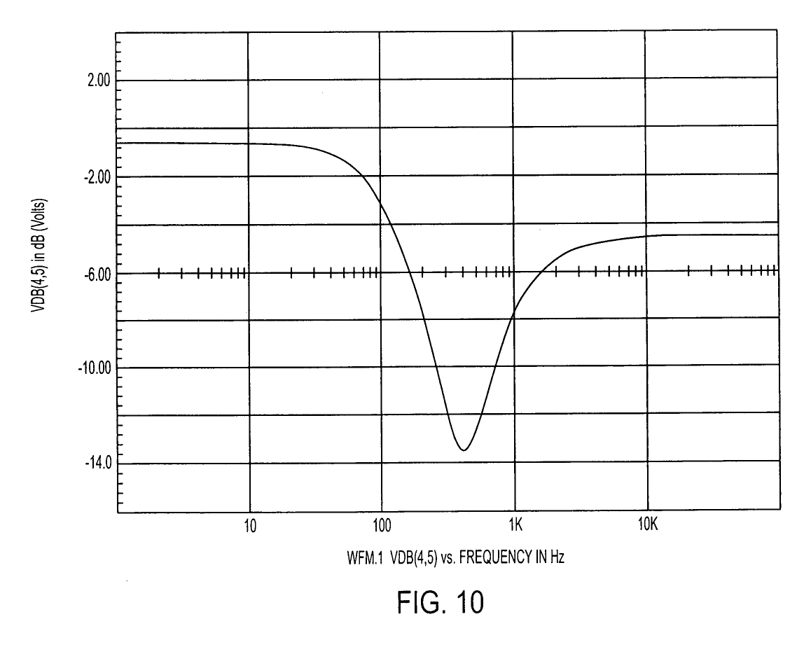

FIG. 10 shows the frequency response of the filter circuit 200 for the kick drum. As shown, the filter circuit 200 may provide band-exclusion filtration, or notch filtration, having a peak at about 400 Hz. Accordingly, the frequencies centered around approximately 400 Hz may be attenuated with respect to the rest of the frequency spectrum in the modified audio signal produced by the filter circuit 200.

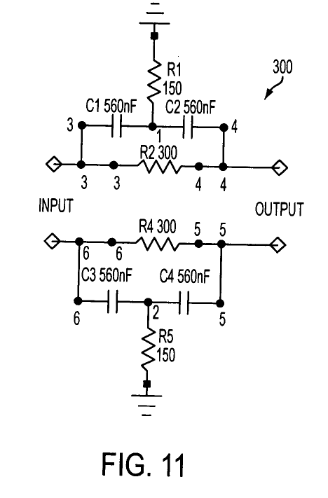

FIG. 11 shows another embodiment of a filter circuit 300 which may be useful, for example, for recording a snare drum. The design of the snare drum filter circuit 300 is similar to that of the kick drum filter circuit 200 with different values selected for the resistors and capacitors. The resistor and capacitor values of the filter circuit 300 may vary the exclusion band, to optimize the frequency response for a snare drum.

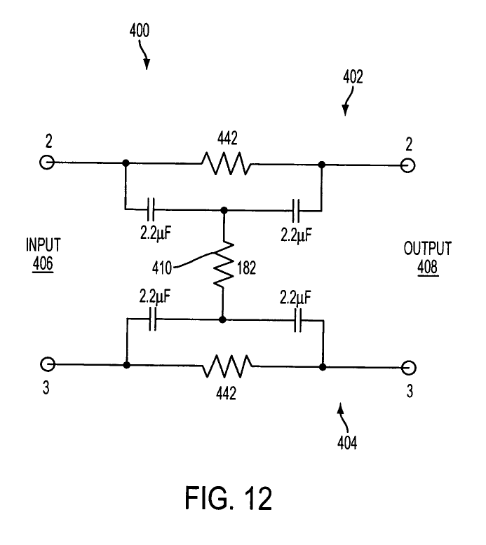

FIG. 12 depicts another embodiment of a filter circuit 400 consistent with the present disclosure. Similar to the general embodiment shown in FIG. 4, the filter circuit 400 may include an two paths 402, 404 having an input side 406 and an output side 408. Rather than including a ground reference, the paths 402, 404 may include a reference therebetween. As shown, the path-to-path reference may include a resistive pathway In some applications, eliminating the ground reference may improve instabilities in the system.

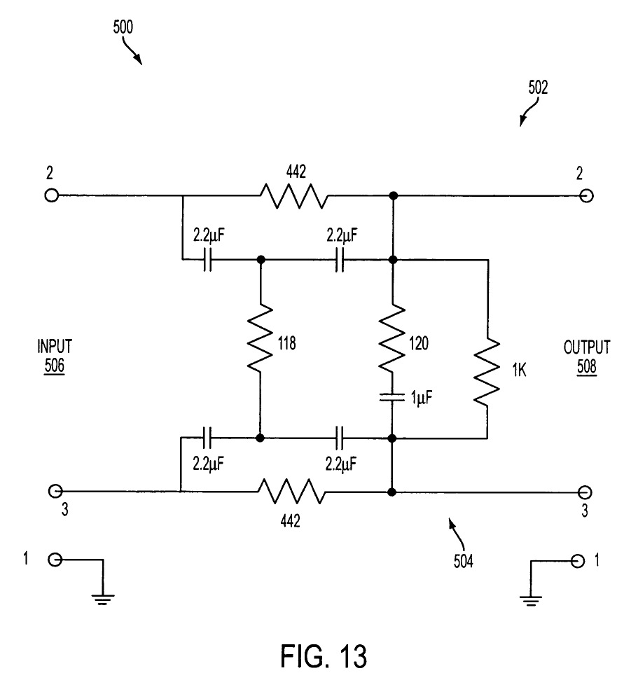

Turning to FIG. 13, yet another embodiment of a filter circuit 500 is shown. Similar to the preceding embodiment, the filter circuit 500 may include a first and second path 502, 504 having an input side 506 and an output side 508. Also similar to the preceding embodiment, the paths 502, 504 include a path-to-path reference, rather than a ground reference. As mentioned above, eliminating the ground reference may improve instabilities when the filter circuit is used with certain varieties of microphones and/or in certain applications.

The resistor and capacitor values indicated in the drawings of the preceding embodiments are set forth as only as exemplary values which may be suitable for particular applications. Other resistor and capacitor values may also be selected for filter circuit designs suitable for recording other types of instruments or acoustic sources or for providing different changes in the sonic characteristics. The circuit designs set forth in the drawings are, similarly, provided only as exemplary filter circuits. Suitable filter circuits may be provided having a variety of configurations and/or designs within the scope of the present invention. As such, the specific resistor and capacitor values and the specific circuit design may vary according to the type of filter, e.g., notch filter, high-pass filter, etc., the desired frequency response, the application, e.g., acoustic source, etc. The present invention should not, therefore, be construed as being limited to the particular capacitor and/or resistor values and/or filter circuit designs of the exemplary embodiments.

In the illustrated embodiments, the filter circuits 200, 300, 400, 500 have a symmetrical design with paths of the balanced line being substantially identical. Each side of the filter circuits 200, 300 include an input, an output and ground. The illustrated embodiments of the filter circuits 200, 300, 400, 500 may be designed such that the overall impedance of the circuits 200, 300, 400, 500 is kept as low as possible. The embodiments of filter circuits 200, 300 including a ground reference may be designed having an impedance of the ground which does not dip below 50 ohms at any frequency to avoid instability in the microphone amplifier circuitry. Those skilled in the art will also recognize that other filter circuit designs may be used.

Consistent with the present disclosure, the in-line filter may provide a DC path from input to output on both sides of the balanced line, i.e., through each path of the filter circuit, to allow the passage of phantom power, for example, for condenser microphones. The resistance of this DC path may be kept as low as possible, for example, not exceeding 2 kohms. Various embodiments of the filter circuit may also be providing not having a DC path from either input or output to ground to avoid loss of phantom power. In an embodiment of an in-line filter for use with a condenser microphone, or other microphone utilizing phantom power, the components in the filter circuit may be able to withstand DC voltages at least equal to, if not greater than, the phantom voltage. For example, the components of the filter circuit may be able to withstand DC voltages of at least about 50V.

An in-line microphone filter consistent with the present disclosure may include a filter configured to be coupled in between a microphone and a preamplifier or other component. An in-line microphone filter may include a housing and a filter circuit housed in the housing. A first connector at one end of the housing may be connected to an input of the filter circuit and a second connector at another end of the filter may be connected to an output of the filter circuit. The filter circuit may filter the audio signal from the microphone by changing sonic characteristics of the signal in a predetermined manner dependent upon a specific type of acoustic source (e.g., a specific instrument).

The terms and expressions which have been employed herein are used as terms of description and not of limitation, and there is no intention, in the use of such terms and expressions, of excluding any equivalents of the features shown and described (or portions thereof), and it is recognized that various modifications are possible. For example, the exemplary circuitry can be implemented in different ways to provide the functionality described herein. Other modifications, variations, and alternatives are also possible.

What is claimed is:

1. An in-line microphone filter comprising:
a filter circuit comprising an input configured to be coupled to a microphone and an output configured to be coupled to a preamplifier, said filter capable of modifying selected frequencies of an input audio signal from said microphone.

2. An in-line microphone filter according to claim 1, wherein said filter circuit comprises a first and a second path

3. An in-line microphone filter according to claim 2, wherein said first and second paths are symmetrical.

4. An in-line microphone filter according to claim 2, wherein said first and second path comprise a ground reference.

5. An in-line microphone filter according to claim 4, wherein said ground reference comprises an impedance greater than or equal to 50 ohms.

6. An in-line microphone filter according to claim 2, wherein said filter circuit comprises a reference between said first and second paths.

7. An in-line filter microphone according to claim 1, wherein said filter circuit comprises a passive filter.

8. An in-line microphone filter according to claim 1, wherein said filter circuit comprises at least one of a band exclusion filter, a band pass filter, a high pass filter, or a low pass filter.

9. A microphone system comprising:
a microphone;
a preamplifier; and
an in-line filter coupled in series between said microphone and said preamplifier, said in-line filter comprising a filter circuit, said filter circuit modifying selected frequencies of an audio signal from said microphone.

10. A system according to claim 9, further comprising a power supply providing a bias voltage.

11. A system according to claim 9, wherein said in-line filter is directly coupled to said microphone.

12. A system according to claim 9, wherein said filter circuit comprises a first and a second DC path from said microphone to said preamplifier.

13. A system according to claim 12, wherein said first and second DC path each comprises a ground reference.

14. A system according to claim 12, wherein said first and second DC path comprise a reference therebetween.

15. A system according to claim 12, wherein said filter circuit comprises at least one of a band exclusion filter, a band pass filter, a high pass filter, or a low pass filter.

16. A method of optimizing an audio signal comprising:
receiving an audio signal from a microphone;
changing a sonic characteristic of selected frequencies of said audio signal based on an acoustic source; and
outputting a modified audio signal to a preamplifier.

17. A method according to claim 16, wherein changing said sonic characteristic of said audio signal comprise filtering said audio signal.

18. A method according to claim 16, wherein changing a sonic characteristic of said audio signal comprises providing a filter circuit coupled between said microphone and said preamplifier.

19. A method according to claim 18, wherein said filter circuit comprises a passive circuit.

20. A method according to claim 19, wherein said filter circuit comprises at least one of a band exclusion filter, a band pass filter, a high pass filter, or a low pass filter.
